(19) United States
(12) Patent Application Publication
(10) Pub. No.: US 2009/0101822 A1
(43) Pub. Date: Apr. 23, 2009

(54) SYSTEM AND METHOD FOR SENSING FUEL MOISTURIZATION

(75) Inventors: Chayan Mitra, Bangalore (IN); Ayan Banerjee, Bangalore (IN); Sandip Maity, Bangalore (IN); Bruce Gordon Norman, Burnt Hills, NY (US); David Wesley Ball, Jr., Easley, SC (US); Aarron Dell Johansen, Greenville, SC (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/874,422

(22) Filed: Oct. 18, 2007

(51) Int. Cl. G01J 3/00; G01N 21/00

(52) U.S. Cl. 250/339.1; 356/51; 356/73; 356/436

(57) ABSTRACT

A fuel moisturization sensor system is disclosed. The fuel moisturization sensor system includes a first light source configured for emitting light through a fuel and moisture flow path at a first wavelength, wherein the first wavelength is at least partially absorbable by the moisture when in a vapor phase and substantially not absorbable by the fuel, and a second light source configured for emitting light through the fuel and moisture flow path at a second wavelength, wherein the second wavelength is preferentially scattered by moisture when in a liquid phase and substantially not absorbed by the fuel or by the moisture when in a vapor phase, a detector system configured to detect light transmitted through the flow path at the first and second wavelengths and to generate a first data signal corresponding to the transmission at the first wavelength and a second data signal corresponding to the transmission at the second wavelength.

### BACKGROUND

The invention relates generally to monitoring and measuring fuel moisturization levels. The invention particularly relates to optical techniques for monitoring and measuring fuel moisturization levels.

Fuel moisturization systems have been used in combined cycle power plants in an attempt to increase power output and thermodynamic efficiency. One example embodiment is described in commonly assigned U.S. Pat. No. 6,389,794. In such systems, natural gas is saturated with water, and the moisturized fuel is heated to saturation conditions at the design gas pressure. The increased gas mass flow due to the addition of moisture results in increased power output from gas and steam turbines.

Natural gas fired combined cycle plants with Dry Low NOx (DLN) combustion systems impose strict requirements on the fuel gas saturation process due to tight fuel specification tolerances. These requirements relate to variables such as heating value, temperature, specific gravity and fuel composition. If fuel supply conditions deviate excessively from the designed fuel specifications, plant performance will degrade.

Lower heating value (LHV), specific gravity (SG), fuel temperature (Tf) and ambient temperature are important parameters that influence the energy of the fuel flowing in the system. Wobbe index (WI) numbers, defined as in Equation 1, provide an indication of energy flow in the system independent of gas pressure and gas pressure drops.

$$WI = \frac{FuelLHV}{\sqrt{SG}} \sqrt{\frac{{T}_{ref}}{{T}_{f}}} , \qquad ( 1 )$$

where reference temperature T_{ref}=288 K. The WI number of the fuel gas supplied to the gas turbine tends to vary significantly in IGCC (integrated gasification combined cycle) plants because the fuel composition from the gasification system varies with load and feedstock to the gasifier. Water is added to the fuel gas to maintain a constant water-to-dry fuel ratio or fuel Wobbe index number to the gas turbine.

Moisturized fuel supply to a DLN gas turbine combustion system requires extremely tight control on the fuel saturation process in a moisturization column due to tight fuel specification tolerances, frequent load changes, and rapid load changes. Typically these DLN systems have at least two operating modes, one that provides robust performance from initial ignition through early loading, and another that provides optimized performance for base or high load conditions. Minimizing system emissions is desirable during operation at high load conditions.

Conventional fuel gas moisturization systems include a three-element control applied to a fuel gas saturation column. Such systems include measurements of the inlet fuel gas flow, make-up water flow, and exiting moisture content in moisturized fuel gas flow. The flow rate of water exiting with the moisturized gas from a moisturization column is measured using coriolis mass flow meters for dry fuel gas and moisturized fuel gas. The flow rate of water leaving the saturator mixed with moisturized fuel gas is given as,

Water component of outletflow=Wet outletfuelflow−Dry inletfuelflow. (2)

Because the fuel moisture in the moisturized stream is small in relation to the total flow, a small error in the total flow measurement may introduce a large error in the moisture content estimation. A more precise estimation of fuel gas composition may be performed using gas chromatography at a pressure of 14.73 psia (˜101.56 kPa) and a temperature of 60° F. (˜15.56° C.). Though accurate, the gas chromatography measurements are time consuming because the process involves sampling of the fuel gas and taking measurements at a reduced pressure and temperature. Further, the gas chromatography method is an off-line measurement of the constituent concentration. Therefore, the information about the components at high pressures and temperatures is not obtainable.

Thus, it would be desirable to have a sensor that can accurately measure on-line moisture content in fuel gas at high pressures and temperatures.

### BRIEF DESCRIPTION

One embodiment disclosed herein is a fuel moisturization sensor system. The fuel moisturization sensor system includes a first light source configured for emitting light through a fuel and moisture flow path at a first wavelength, wherein the first wavelength is at least partially absorbable by the moisture when in a vapor phase and substantially not absorbable by the fuel, and a second light source configured for emitting light through the fuel and moisture flow path at a second wavelength, wherein the second wavelength is preferentially scattered by moisture when in a liquid phase and substantially not absorbed by the fuel or by the moisture when in a vapor phase, a detector system configured to detect light transmitted through the flow path at the first and second wavelengths and to generate a first data signal corresponding to the transmission at the first wavelength and a second data signal corresponding to the transmission at the second wavelength.

Another embodiment disclosed herein is a gasification system. The gasification system including a gasifier, a fuel moisturization system, a conduit for transferring a fuel and moisture mixture from the fuel moisturization system to the gasifier, and an on-line fuel moisturization sensor system disposed external to the gasifier, wherein the sensor system includes a first light source configured for emitting light through a fuel and moisture flow path at a first wavelength, wherein the first wavelength is at least partially absorbable by the moisture when in a vapor phase and substantially not absorbable by the fuel, a second light source configured for emitting light through the fuel and moisture flow path at a second wavelength, wherein the second wavelength is preferentially scattered by moisture when in a liquid phase and substantially not absorbed by the fuel or by the moisture when in a vapor phase, and a detector system configured to detect light transmitted through the flow path at the first and second wavelengths and to generate a first data signal corresponding to the transmission at the first wavelength and a second data signal corresponding to the transmission at the second wavelength.

Still another embodiment disclosed herein is a method for monitoring fuel moisturization levels. The method includes interrogating a fuel and moisture mixture with light at a first wavelength, detecting light at the first wavelength transmitted through the fuel and moisture mixture to generate a data signal corresponding to light absorbed at the first wavelength by the moisture in a vapor phase along a path of light transmittance through the fuel and moisture mixture, detecting a reference light signal at the first wavelength to generate a reference data signal corresponding to an intensity of the light at the first wavelength interrogating the fuel and moisture mixture, and determining a moisture level in vapor phase in the fuel and moisture mixture.

Yet another embodiment disclosed herein is a fuel moisturization sensor system. The fuel moisturization sensor system includes a first light source configured for emitting light through a fuel and moisture flow path at a first wavelength, wherein the first wavelength is at least partially absorbable by moisture when in a vapor phase and substantially not absorbable by the fuel, a second light source configured for emitting light through the fuel and moisture flow path at a second wavelength, wherein the second wavelength is preferentially scattered by particulate matter and substantially not absorbable by the fuel or by moisture when in a vapor phase, a third light source configured for emitting light through the fuel and moisture flow path at a third wavelength, wherein the third wavelength is at least partially absorbable by the moisture when in liquid phase and substantially not absorbable by the fuel or moisture when in vapor phase, and a detector system configured to detect light transmitted through the flow path at the first, second, and third wavelengths and to generate a first data signal corresponding to the transmission at the first wavelength, a second data signal corresponding to the transmission at the second wavelength, and a third data signal corresponding to the transmission at the third wavelength.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a method to measure moisture levels in a fuel and moisture mixture in one embodiment disclosed herein.

FIG. 2 is a schematic representation of a sensor system for measuring moisture levels in a fuel and moisture mixture in one embodiment disclosed herein.

FIG. 3 is a schematic representation of a sensor system for measuring moisture levels in a fuel and moisture mixture in one embodiment disclosed herein.

FIG. 4 is a schematic representation of a sensor system for measuring moisture levels in a fuel and moisture mixture in one embodiment disclosed herein.

FIG. 5 is a schematic representation of a fuel moisturization system in a gasification system in one embodiment disclosed herein.

FIG. 6 is a graphical representation of absorption spectra for water vapor, N₂, CO, CO₂, C₂H₄, C₂H₆ and CH₄ in one embodiment disclosed herein.

FIG. 7 is a graphical representation of absorption spectra for water vapor, O₂, COS, SO₂, H₂S, NO₂, NO and C₂H₂ in one embodiment disclosed herein.

FIG. 8 is a graphical representation of the measured variation in intensity during a moisturization process in one embodiment disclosed herein.

FIG. 9 is a graphical representation of the measured variation in intensity during a moisturization process in one embodiment disclosed herein.

### DETAILED DESCRIPTION

As used herein the term “moisture” refers to both moisture when present in a vapor and moisture when present in liquid phase. Moisture in vapor phase is also interchangeably referred to herein as water vapor or steam.

As used herein the term “fuel” refers to gaseous phase natural gas or gasified coal suitable for combustion in industrial or power plant applications, for example. Non-limiting examples of molecular components of fuel include H₂, H₂O, N₂, CO, CO₂, C₂H₂, C₂H₄, C₂H₆, CH₄, O₂, COS, SO₂, H₂S, NO₂, and NO.

As used herein particulate matter refers to solid and liquid particles entrained in the flowing fuel stream. Non-limiting examples includes liquid phase moisture particles and impurity particulates such as that of metals, hydrocarbons, dirt, and dust.

In the following specification and the claims that follow, the singular forms “a”, “an” and “the” include plural referents unless the context clearly dictates otherwise.

Embodiments disclosed herein include systems and methods for determining vapor and/or liquid phase moisture levels in a fuel and moisture mixture.

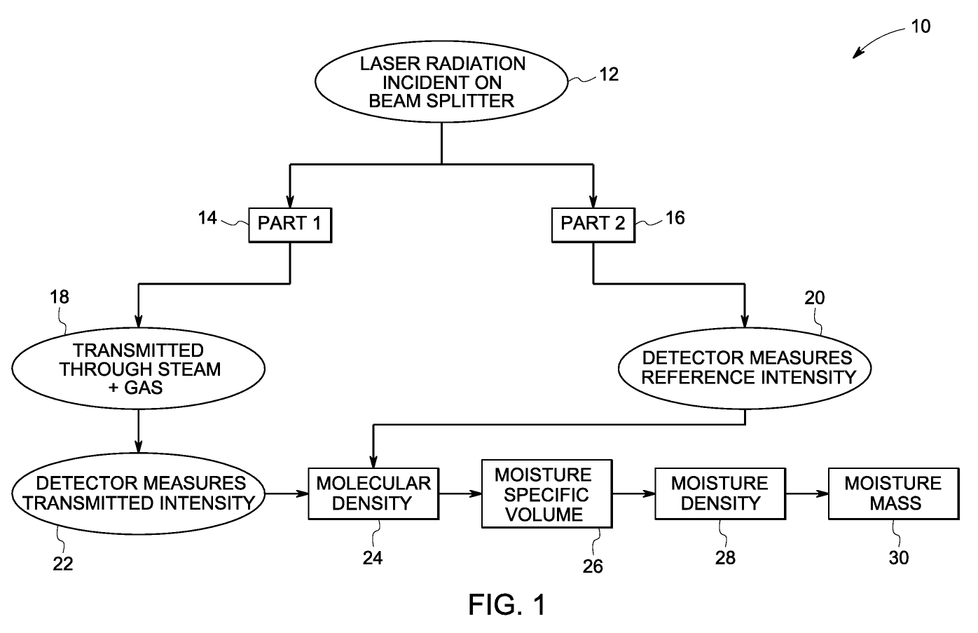

FIG. 1 illustrates a method 10 for determining moisture levels in a moisture and fuel mixture. The method 10 includes splitting using a beam splitter 12 an incident laser beam into two parts 14 and 16. A first part of the beam 14 is transmitted 18 through a mixture of gas, which includes steam and may include one or more molecular species such as O₂ and COS for example. The transmitted beam is incident on a detector that measures the intensity of the transmitted beam 22 and gives a measure of the absorption though the gas and steam mixture. Concurrently a second part of the beam 16 is directly incident on a reference detector for detection 20 and determination of the intensity of the directly transmitted beam. The measured intensity at both detectors is used to first determine the molecular density 24 of the mixture, from which the moisture specific volume 26 is estimated and the moisture density 28 and moisture mass 30 are calculated. If the wavelength of the incident beam is such that only water vapor molecules absorb at wavelength of the incident beam, then the measured intensity of the beam through the steam and gas mixture corresponds to the mass of water vapor in the mixture.

In one embodiment, a fuel moisturization sensor system includes a first light source at a first wavelength configured to interrogate a fuel and moisture flow path. The first wavelength is at least partially absorbable by the moisture when in a vapor phase and substantially not absorbable by the fuel. In one example, the first wavelength is selected to be in the infrared wavelength range. In another example, the first wavelength is selected to be in range from 925 to 975 nm. In one embodiment, “substantially not absorbed or absorbable” means that the absorption level is less than the noise level of the sensor system. In a specific embodiment, “substantially not absorbed or absorbable” means that the absorption is in the range of less than or equal to one percent of the initial intensity level of the moisture. In one embodiment, “at least partially absorbable” means that the absorption level is greater than the noise level of the sensor system. In a specific embodiment, “at least partially absorbable” means that the absorption is in the range of at least three percent of the initial intensity level of the moisture. In a more specific embodiment, particularly for elevated temperatures and pressures, “at least partially absorbable” means at least ten percent of the initial intensity level of the moisture is absorbed.

A second light source is at a second wavelength that is preferentially scattered by moisture when in a liquid phase and substantially not absorbed by the fuel or by the moisture when in a vapor phase. The second light source may be used to determine levels of particulate matter in the fuel and moisture mixture or in or on the chamber containing the fuel and moisture mixture. In one example, the second wavelength is selected to be in the visible wavelength range. In another example, a second wavelength is selected to be in range from 610 nm to 650 nm. As used herein, “preferentially scattered” means that the scattering cross-section is several times higher for the liquid phase as compared to the vapor phase.

A third light source may also be included in the system to interrogate the fuel and with a wavelength that is at least partially absorbable by moisture when in liquid phase and substantially not absorbable by the fuel or moisture when in vapor phase. In one example, a third wavelength is selected to be in a range from 1525 nm to 1575 nm.

The sensor system may further include detectors to detect the transmitted intensities of the interrogating light at one or more wavelengths and acquisition and analysis systems to determine parameters such as moisture levels and particulate matter levels based on the measured transmitted intensities.

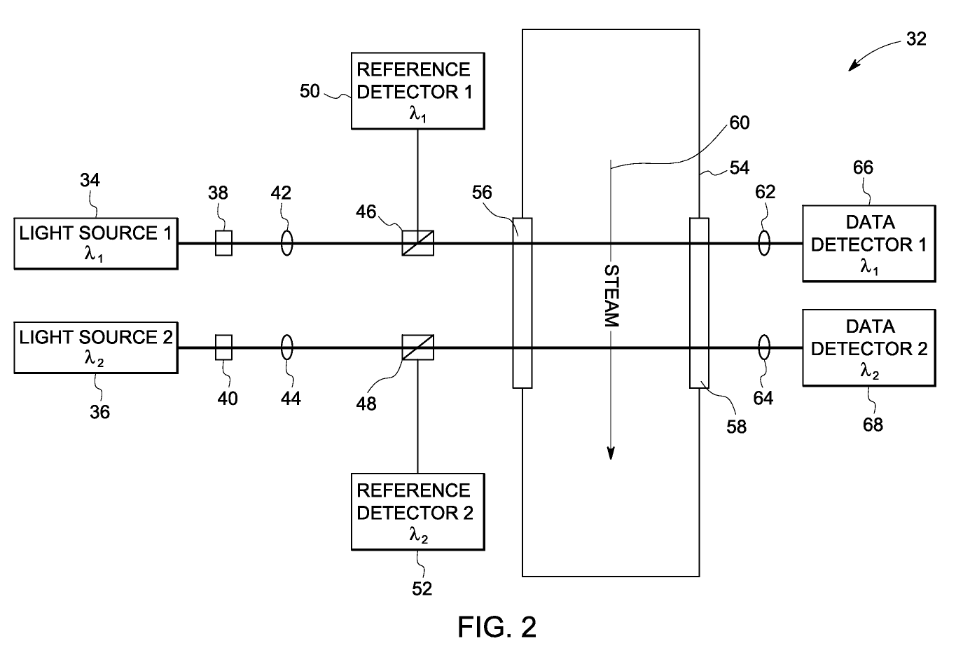

FIG. 2 illustrates a fuel moisturization sensor system 32 in one embodiment. The sensor system 32 includes a first light source 34 lasing at a peak frequency of λ₁ and a second light source 36 lasing at a peak frequency of λ₂, wherein the light from sources 34 and 36 is transmitted through windows 56 and 58 of a conduit 54 carrying a moisture and fuel mixture. In one example, light at a wavelength of λ₁ is at least partially absorbable by moisture when in a vapor phase and not absorbable by the fuel and particulate matter in the fuel and moisture mixture or on the windows of the conduit. In a non-limiting example, particulate matter is liquid phase moisture. In a non-limiting example, λ₂ is chosen such that it is preferentially scattered by particulate matter on the windows or in the gas and steam mixture, leading to a reduction in the transmitted intensity at λ₂. Light from the sources 34 and 36 is incident on respective bandpass filters 38 and 40 and focused using spherical lenses 42 and 44 respectively before being incident on beam splitters 46 and 48. At each beam splitter part of the light is reflected towards a respective reference detectors 50 or 52 and part of the incident light is transmitted towards the conduit 54 with entrance and exit windows, for example glass windows, 56 and 58 in the conduit carrying the gas and steam mixture 60. Upon exiting the exit window 58 the transmitted light is again focused using respective lenses 62 and 64 and is then incident on data detectors 66 and 68 respectively.

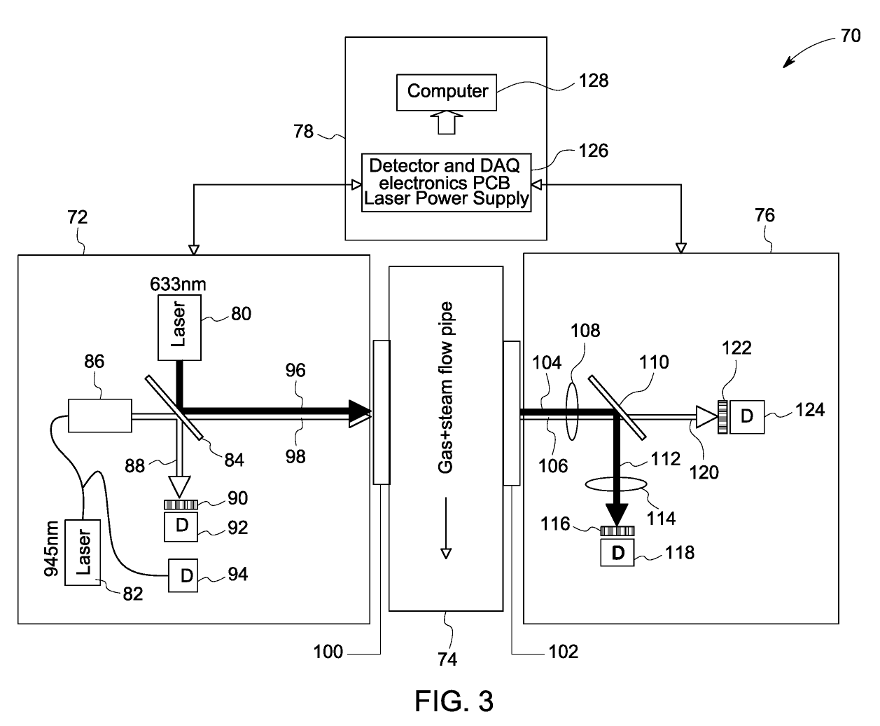

The embodiment of FIG. 3 illustrates a fuel moisturization sensor system 70 configured for determining a level of vapor phase moisture in a fuel and moisture mixture. The system includes the interrogation system 72, to interrogate a fuel and moisture transporting chamber 74, a detector system 76, and a control and data acquisition and analysis system 78. The interrogation system 72 includes two laser sources 80 and 82 emitting at wavelengths of about 633 nm and about 945 nm. Light at 945 nm is absorbed by moisture in the vapor phase and is not absorbed by molecules typically found in a fuel. The 633 nm light is preferentially scattered by particulate matter, specifically liquid moisture. In a non-limiting example, any condensation of vapor on to the windows resulting in moisture in the liquid phase on the windows will lead to loss in the transmission intensity at this wavelength. Additionally, any particulate matter in the fuel could also lead to loss in the transmitted intensity due to scattering. The light from the two lasers is combined at the beam splitter 84. A part of the radiation emitted by the laser 82 is carried by a fiber to a reference detector 94 and is detected and measured by the reference detector 94, while a second part of radiation is carried by another fiber to a collimator 86 before being incident on the beam splitter 84, which transmits the light radiation 96 at 945 nm towards the chamber 74. The output of laser 80 at the wavelength of about 633 nm is split by the beam splitter 84 and is partially directed towards a reference detector 92 after being collimated by a collimator 90 and partially directed towards the chamber 76. The chamber 76 includes entrance windows 100 and 102. Light radiation at wavelengths of 945 nm and 633 nm, after absorption and/or scattering through the chamber, emerges from the chamber as beams 104 and 106 and is focused using a lens 108 and then incident on splitter 110. The reflected beam at 633 nm 112 is focused using a lens 114 and collimated using a collimator 116 before being incident on a data detector 118. The radiation at 945 nm 120 is directed by the splitter 110 towards collimator 122 and is subsequently detected by detector 124. The output of the detectors is received by the detector and data acquisition electronics 78 and is sent to a computer 128 for analysis.

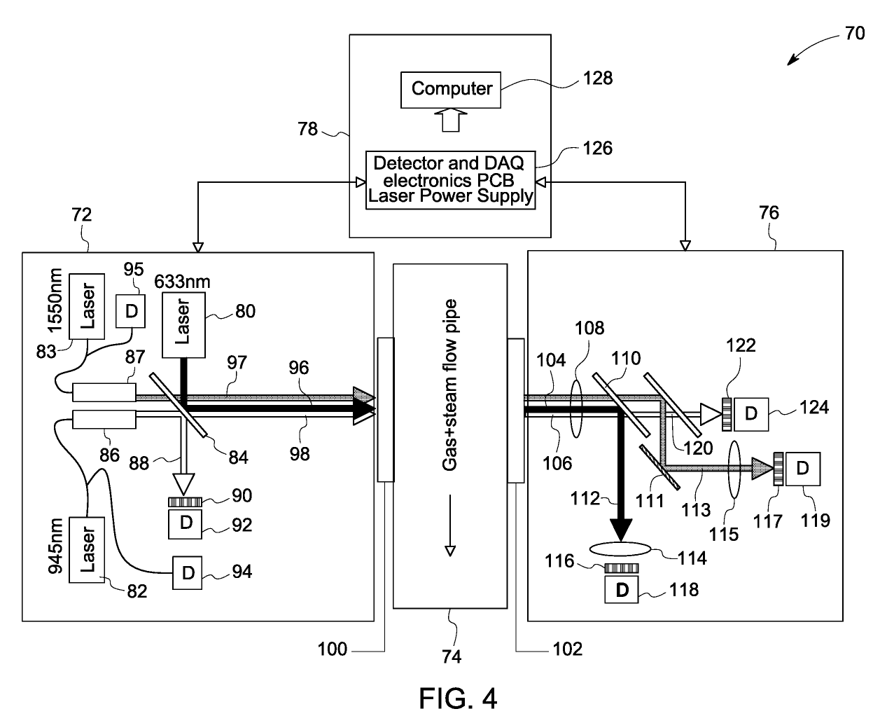

Although in some scenarios the moisture in a moisture and fuel mixture for gasification mostly includes vapor phase moisture, there are other scenarios wherein moisture in liquid phase may also be present in significant levels in the mixture and can be advantageously determined. In an alternate embodiment illustrated in FIG. 4, the moisturization sensor system 72 may include an additional third laser for probing the levels of moisture in the liquid phase in the fuel and moisture mixture. The system further includes laser 83 emitting at a peak wavelength of about 1550 nm in one example. Light at 1550 nm is absorbed by liquid phase moisture but is not significantly absorbed by the component molecules of the fuel or by vapor phase moisture. A part of the output of laser 83 is incident on a collimator 87 and is subsequently transmitted through the splitter 84 and is incident on the chamber 74. A second part of the output of the laser 83 is carried through a fiber to a reference detector 95. The transmitted beam 113 emerging out of the chamber is subsequently focused using lens 115 and collimated using collimator 117 and is detected by the detector 119. The measured intensities of the transmitted beams at wavelengths of 633 nm, 945 nm, and 1550 nm are acquired by the control and data acquisition and analysis system and subsequently analyzed to determine a value of vapor phase moisture, liquid phase moisture, and total moisture in the fuel and moisture mixture.

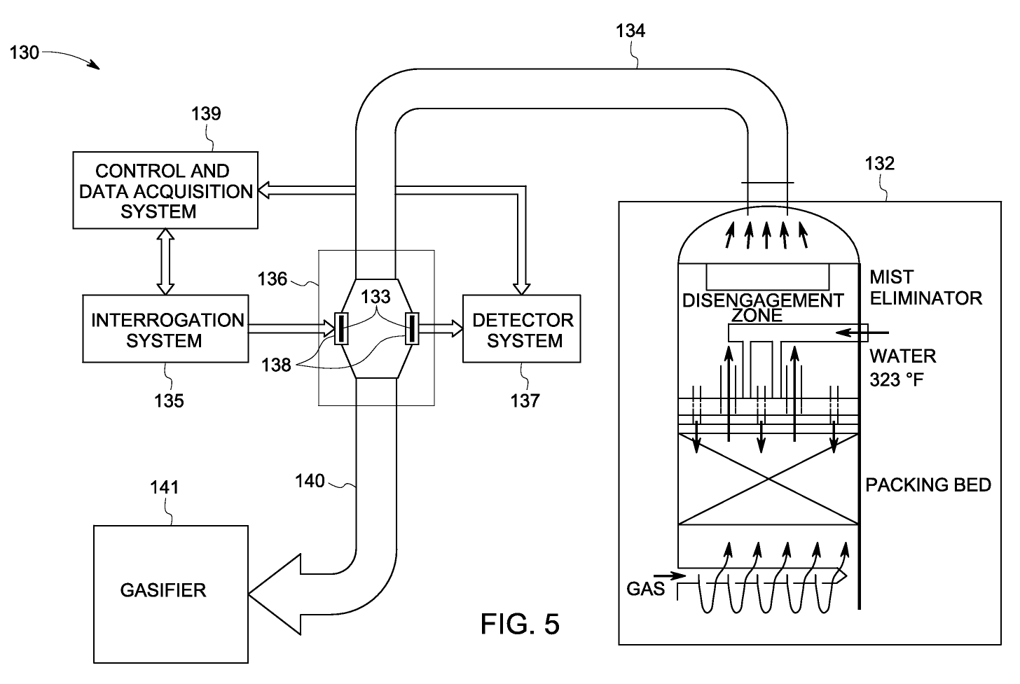

In another embodiment, a gasification system 130 includes a fuel moisturization system 132 as illustrated in FIG. 5. The moisturized fuel is conducted through a conduit 134 and enters the interrogation chamber 136. For example, typically in IGCC, the moisture concentration in the fuel gas from the moisturization column varies from eighteen percent to twenty percent. The interrogation chamber has two windows 138, for interrogation beams from the interrogation system to enter and exit the chamber 136. Upon transmission through the chamber, a transmitted intensity of the beams is measured by the detector system 137. In one embodiment, the windows may include heating elements 133, which may be turned on to keep the windows at an elevated and temperature and consequently free of any moisture condensation. In a specific example, the heating elements may be turned on in response to a fall in the transmitted intensity of light at a wavelength where there is significant absorption by moisture in the liquid phase indicating presence of condensed moisture on the windows. The moisturized fuel exits the interrogation chamber and is transported through conduit 140 into the gasifier 141. In a non-limiting example, detectors for measuring intensities of the reference beams corresponding to the interrogation beams may be found in the interrogation system. In one embodiment, the control and data acquisition system supplies power to the interrogation and detector systems and also receives reference intensity and transmitted intensity data for further processing and analysis.

In one example, the fuel moisturization system in a gasification system is configured to receive a determined moisture to fuel ratio data and operable to modify the moisture to fuel ratio in the fuel and moisture mixture.

In one embodiment, a method for monitoring fuel moisturization levels includes interrogating a fuel and moisture mixture with light at a first wavelength to generate a data signal corresponding to light absorbed at the first wavelength by the moisture in a vapor phase along a path of light transmittance through the fuel and moisture mixture to determine a moisture level in vapor phase in the fuel and moisture mixture.

In a further embodiment, the method includes interrogating at a second wavelength to measure the presence of any particulate matter in the fuel and moisture mixture or along the transmission path, for example on a chamber containing the fuel and gas mixture. Light at the second wavelength, for example 633 nm is typically scattered by particulate matter. In a still further embodiment, light at a third wavelength, characteristic of an absorption peak of liquid phase moisture, is used to detect and measure the presence of liquid phase moisture in the fuel and moisture mixture.

In one embodiment, the moisture levels can be monitored on-line in real time in a system such as a gasification system to dynamically change moisture levels in the fuel and moisture mixture as desired.

Any appropriate technique may be used by the control and data acquisition system to analyze the detected data. In one embodiment, a method includes determining a molecular density of moisture in vapor phase by calculations including Beer-Lambert's relation, as discussed below. In a further embodiment, pressure and/or temperature corrections are applied to the absorption line width and shape calculations.

Typically in fuel, many different molecular species are found. Table 1 provides a list of the typical natural gas constituents and their percentage by molecular weight and by mole percent.

TABLE 1
Constituent molecular species of natural gas

| Component | Formula | Mol Wt | Mole % |
|---|---|---|---|
| Helium | He | 4.0026 | 0 |
| Hydrogen | H₂ | 2.0159 | 0 |
| Oxygen | O₂ | 31.9988 | 0 |
| Argon | Ar | 39.948 | 0 |
| Nitrogen | N₂ | 28.0134 | 0.323 |
| Carbon dioxide | CO₂ | 44.01 | 0.873 |
| Carbon monoxide | CO₂ | 0106 | 0 |
| Methane | CH₄ | 16.043 | 95.601 |
| Ethane | C₂H₆ | 30.0701 | 2.427 |
| Propane | C₃H₈ | 44.0972 | 0.457 |
| I-Butane | C₄H₁₀ | 58.1243 | 9.40E−02 |
| N-Butane | C₄H₁₀ | 58.1243 | 9.40E−02 |
| Neo-Pentane | C₅H₁₂ | 72.1514 | 0.00E+00 |
| I-Pentane | C₅H₁₂ | 72.1514 | 3.70E−02 |
| N-Pentane | C₅H₁₂ | 72.1514 | 2.60E−02 |
| C-6 and heavier | C₆H₁₄ | 86.1785 | 6.80E−02 |

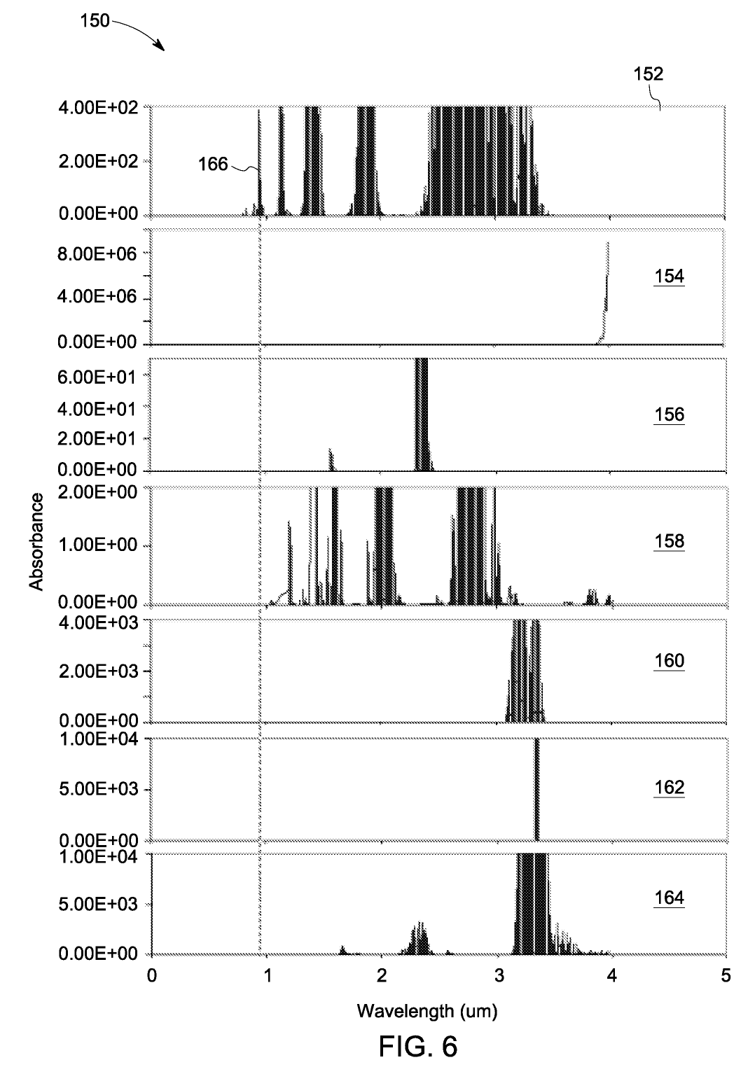

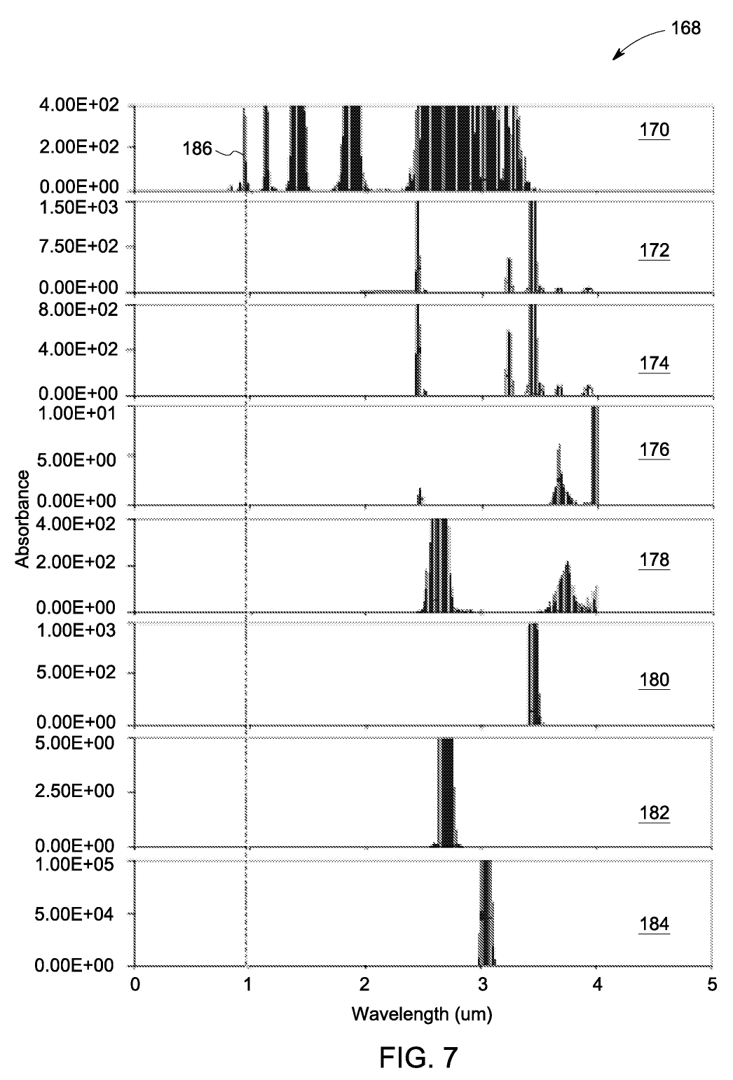

FIGS. 6 and 7 illustrate the absorption spectra 150 of many molecular components found in fuel, such as but not limited to natural gas, compared with spectra of vapor phase moisture. The shown absorption spectra are derived from the HITRAN (high-resolution transmission molecular absorption) database.

In FIG. 6, line plot 152 illustrates the absorption spectra of vapor phase moisture. Line plots 154, 156, and 158 illustrate the absorption characteristics of N₂, CO and CO₂ respectively. Line plots 160, 162, and 164 illustrate the absorption characteristics of C₂H₄, C₂H₆ and CH₄ respectively. Although part of the water vapor spectra 152 overlaps with the absorption spectra of some of the other molecular species, other parts do not. Water vapor exhibits strong rotational and vibrational absorption bands in the near IR (NIR) range of the electromagnetic spectrum. At a wavelength of 945 nm, absorption by steam is high without any overlap with other constituents. As a result, a part of the radiation from laser is absorbed by steam. The reference line 166 marks the wavelength 945 nm at which a significant absorption line is found for vapor phase moisture, which is absent in any of the above discussed fuel components.

Similarly, in the comparative plot 168 of FIG. 7, line plot 170 shows the absorption spectra for vapor phase moisture. Line plots 172, 174, and 176 illustrate the absorption characteristics of O₂, COS, and SO₂ respectively. Line plots 180, 182, 184, and 186 illustrate the absorption characteristics of H₂S, NO₂, NO, and C₂H₂ respectively. Reference line 186 marks the wavelength 945 nm at which a significant absorption line is found for vapor phase moisture, which is not found in any of the above discussed fuel components.

Therefore, vapor phase moisture has an absorption characteristic that is not found in typical components in a fuel and hence can be used as a signature to detect the presence of vapor phase moisture and measure the vapor levels. Therefore, in one embodiment, the wavelength used to probe the vapor phase moisture is selected based on the absorption spectra of the other molecular species the vapor molecules that are present with in the mixture.

In one embodiment, the molecular density of moisture in vapor phase may be calculated using Beer-Lambert's relation given by:

$$\frac{I}{{I}_{O}} = exp ( - {S}_{{η}^{″} {η}^{′}} ( T ) f ( v , {v}_{O} , T , P ) {N}_{i} L ) \qquad ( 3 )$$

where, I₀ is the reference intensity, I is the transmitted intensity, S_{θ″θ′} (T) is the line strength, f(v,v_{O}, T, P) is the line shape function, Nᵢ is the molecular density, and L is the path length of the beam. The line strength and the line shape functions of the interrogating laser radiation are dependent on the temperature and pressure as is well know in the art.

From Equation 3, the molecular density can be written as:

$${N}_{i} = \frac{ln ( \frac{{I}_{O}}{I} )}{{S}_{{η}^{″} {η}^{′}} ( T ) {\int }_{v 1}^{v 2} f ( v , {v}_{O} , T , P ) L } . \qquad ( 4 )$$

The above equation indicates that the molecular density is a function of reference and transmitted intensity. Using the above Equation (4), the specific volume can be calculated as:

v=Nₐᵥ/(Nᵢ*MW_{H}_{₂}_{O}) (5)

where Nav is the Avogrado number (molecules/mol) and MWH₂O (gm/mol) is the molecular weight of water.

The density (ρ) of steam in the fuel gas mixture is then calculated using the relation

$$ρ = \frac{1}{v} . \qquad ( 6 )$$

Multiplying the density with the volume of the vessel gives the mass of steam contained in the fuel gas mixture at any instant.

In some embodiments, the absorption line shape may be corrected to take into consideration the broadening of the absorption line due to elevated temperature and pressure conditions.

In one example, the operational pressure ranges from 500 psi (˜3450 kPa) to 600 psi (4140 kpa) and temperature is at least 400° F. (˜204° C.) At such a high pressure and temperature, there is a chance of absorption line broadening. Therefore knowledge of absorption line characteristics as a function of temperature and pressure is useful for the application of a spectroscopic based sensor in industrial environments.

The absorption line spectral shifts as a function of pressure and temperature is described in many references, such as Richard Phelan et al, “Absorption line shift with temperature and pressure: impact on laser-diode-based H2O sensing at 1.393 um,” Appl. Optics, Vol. 42, No. 24, pp. 4968-4974, 2003. The absorption line shapes have finite widths, which are mainly dependent on Doppler and collisional (pressure) broadening mechanisms. The absorption line width AVD at full width half-maximum (FWHM) in the Doppler limit is defined by

ΔV_{D}=v_{O}/c[(2kT ln 2/m)]^{1/2} (7)

where v_{O} is the centre frequency, T is the temperature in degrees Kelvin, k is the Boltzmann's constant, m is the mass of the molecule, and c is the speed of light. The spectral shift and broadening of an absorption line, as a function of pressure and temperature is described by Equations (8) and (9), respectively,

V_{P}=V_{R}+δ*P, (8)

2γ(T)=2γ(T_{O})(T_{O}/T)^{N}, (9)

where V_{P} and V_{R} are the wavelengths of the peak absorption profiles at a pressure P and reference pressure R, respectively, and δ is the pressure-induced line-shift coefficient. In Equation (9), T₀ is the reference temperature, 2γ(T₀) is the broadening coefficient at the reference temperature, and N is the temperature-dependent exponent.

As reported in the aforementioned Phelan reference, the maximum measured spectral shift coefficient with pressure is 2.29×10⁻⁶ nm/mbar at room temperature. The variation of the shift coefficient as a function of temperature in the range of 300° K-1100° K is given in the same reference. Temperature broadening can shift the wavelength b plus or minus 0.03 nm/° C. In one example, a maximum shift at 600° F. (316° C.) is 9.46 nm. Pressure broadening can also shift the wavelength by plus or minus 0.0001 nm/Torr. This results in a shift of 2.75 nm at 550 psi (˜3.790 kPa).

Comparing line plots 152 (water vapor) and 158 (CO₂) of FIG. 6, Δλ for CO₂ (the closest spectra) and water vapor laser is 91 nm (approx.). So any overlap of the absorption spectra at high temperatures and pressures, as encountered in a moisturization tower in a gasification system for example, for CO, CO₂, and other hydrocarbons is shown not to occur.

Without further elaboration, it is believed that one skilled in the art can, using the description herein, utilize the embodiments disclosed herein to their fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

An experiment was carried out to measure moisture levels in steam mixed in nitrogen (N₂) and carbon dioxide (CO₂). A high temperature and pressure gas vessel with gas and steam connections was designed and fabricated for the purpose of conducting the experiments. The gas vessel was designed to withstand a pressure of 150 psia (˜1034.25 kPa) at 150° C. The maximum working pressure for this example was 80 psia (˜551.6 kPa). The windows in the gas vessel consisted of 6 mm thick quartz glass of 3-inch diameter. In order to remove moisture condensation on the windows, the windows were heated to 200° C. The temperature and pressure inside the gas vessel during the experiment were monitored using a thermocouple and a pressure gauge.

The interrogating laser radiation at 945 nm and 633 nm was divided into two parts each using a beam splitter. One part was incident on the gas vessel on one of the windows and the transmitted radiation detected through the other window. The second part was used as a reference for measurement of incident power.

The data was acquired at a 500 kHz rate and the data fed to algorithms written in MATLAB® to calculate the steam mass fraction in a gas mixture. The Beer's law and the steam line function were implemented in MATLAB in the algorithms used to calculate the steam levels.

### EXAMPLE 1

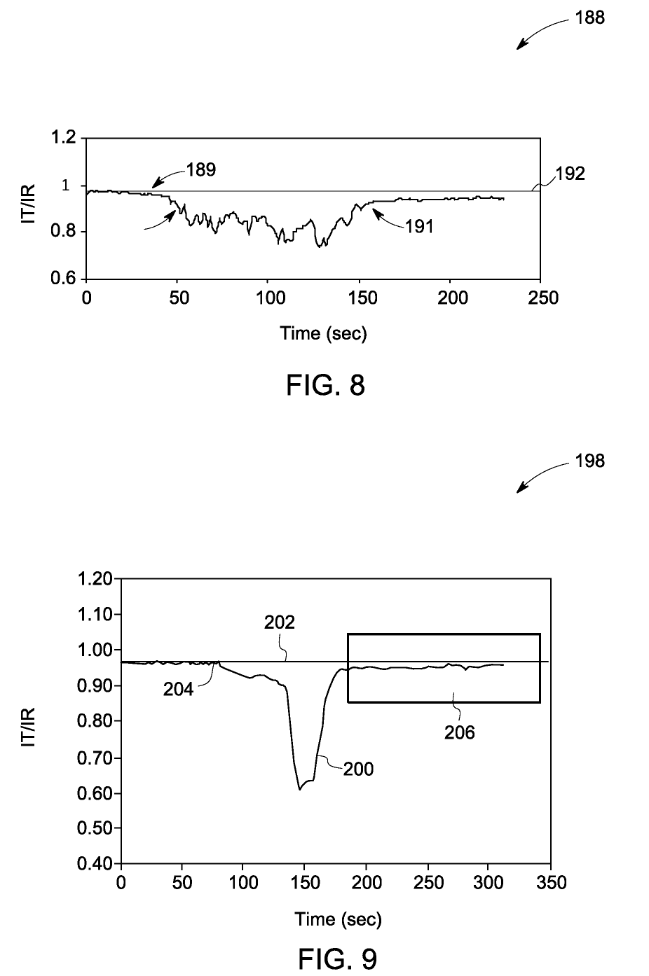

The vessel was evacuated and filled with nitrogen up to a desired pressure. A data acquisition system acquiring the data from the moisturization sensor system was initiated and the transmitted and reference intensities were monitored. Steam was introduced in the vessel and the transmitted and reference intensities were monitored. FIG. 8 illustrates the variation of transmitted intensity through N₂ at 55 psi (˜379 kPa) and steam at 10 psi (˜68 kPa).

The absorption feature of light at 945 nm in FIG. 8 shows that as the steam was introduced inside the chamber at point 189, there was a drop 190 in the transmitted intensity till a steady state was attained again at and beyond point 191. Line 192 marks the baseline intensity level.

The steam mass was measured at different steam and N₂ pressures. The results were validated using thermodynamic table based calculations and pressure, volume, and temperature (P, V, T) based calculations. For thermodynamic table based calculations, the steam temperature was measured using a k-type thermocouple inserted inside the steam chamber. For P, V, T based calculations, the steam pressure inside the chamber is calculated by the difference of chamber pressure with nitrogen plus steam mixture and nitrogen alone (before steam introduction in the chamber). Table 2 summarizes steam mass measurement at different steam pressures

TABLE 2
Steam mass measurements at different steam pressures with N₂ in the chamber.

| | | | | | Mass of | |
|---|---|---|---|---|---|---|
| Steam | Total | | | Mass | steam (kg) | Moisture % |
| Pressure | Pressure | | Mass of | of | from Pressure | from Pressure & |
| (psia) | (psia) | Temperature | Steam | steam | &Temperature | Temperature |
| (~×6.895 kPa) | (~×6.895 kPa) | (K) | measured (kg) | TT (kg) | measurement | measurement) |
| 28.4 | 62.75 | 390 | 0.02552 | 0.0252 | 0.0248 | 34.714 |
| 29 | 59.8 | 382.3 | 0.02581 | 0.0258 | 0.0258 | 37.7155 |
| 27.5 | 52.9 | 389.55 | 0.02498 | 0.0240 | 0.0240 | 41.0479 |
| 28.3 | 50.6 | 395.85 | 0.2498 | 0.0243 | 0.0243 | 44.9387 |
| 29.5 | 52 | 393.3 | 0.026 | 0.255 | 0.255 | 45.7466 |
| 27.7 | 52 | 390.5 | 0.249 | 0.241 | 0.241 | 42.3001 |

A comparative table of average steam mass measured using the fuel moisturization sensor, thermodynamic table based calculations and P, V, T based measurements is given in Table 3. It can be noted that the average steam mass as detected by fuel moisturization sensor is very near to the average steam mass value estimated using thermodynamic table based calculation and P, V, T based measurements. This indicates that the sensor is capable of detecting moisture content in gas-steam mixtures.

TABLE 3
Comparative table of average steam mass estimated through three
different methods.

| | | P, V, T based | Thermodynamic |
|---|---|---|---|
| | Fuel moisture sensor | calculated | Table based |
| | measurement | values | calculated values |
| Average steam | 0.02489 | 0.024576 | 0.025 |
| mass (kg) | | | |
| Standard | 0.00062 | 0.0006 | 0.000835 |
| deviation | | | |

### EXAMPLE 2

The vessel was evacuated and filled with carbon dioxide up to a desired pressure. A data acquisition system acquiring the data from the moisturization sensor system was initiated and the transmitted and reference intensities were monitored. Steam was introduced in the vessel and the transmitted and reference intensities were continued to be monitored. FIG. 9 illustrates the variation of transmitted intensity through CO₂ at 30 psi (˜207 kPa) and steam at 10 psi (˜68 kPa).

Line 202 marks the baseline intensity level. The absorption feature of light at 945 nm in FIG. 9 shows that as the steam was introduced inside the chamber at point 204, there was a drop 200 in the transmitted intensity till a steady state was attained again in the region 206. The DC shift due to absorption of 10 psi (68 kPa). steam in the steam+CO₂ mixture is indicated in the FIG. 9. This DC shift in the absorption spectra is used to calculate the steam mass in the gas mixtures.

In one embodiment, the discussed examples 1 and 2 demonstrate the ability of the moisturization sensor to monitor and track the transients in steam mass due to steam introduction in the chamber containing either N₂ or CO₂.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel moisturization sensor system comprising:
a first light source configured for emitting light through a fuel and moisture flow path at a first wavelength, wherein the first wavelength is at least partially absorbable by the moisture when in a vapor phase and substantially not absorbable by the fuel; and
a second light source configured for emitting light through the fuel and moisture flow path at a second wavelength, wherein the second wavelength is preferentially scattered by moisture when in a liquid phase and substantially not absorbed by the fuel or by the moisture when in a vapor phase;
a detector system configured to detect light transmitted through the flow path at the first and second wavelengths and to generate a first data signal corresponding to the transmission at the first wavelength and a second data signal corresponding to the transmission at the second wavelength.

2. The fuel moisturization sensor system of claim 1, wherein the first wavelength is selected to be in the infrared wavelength range.

3. The fuel moisturization sensor system of claim 2, wherein the first wavelength is selected to be in a range from 925 to 975 nm.

4. The fuel moisturization sensor system of claim 1, wherein the second wavelength is selected to be in the visible wavelength range.

5. The fuel moisturization sensor system of claim 4, wherein the second wavelength is selected to be in a range from at 610 nm to 650 nm.

6. The fuel moisturization sensor system of claim 1, further comprising first and second reference detectors, wherein a portion of the light from the first light source at the first wavelength is detected by the first reference detector and a portion of the light from the second light source at the second wavelength is detected by the second reference detector to generate first and second reference data signals corresponding to the intensity of light at first and second wavelengths respectively, incident on the flow path.

7. The fuel moisturization sensor system of claim 6, further comprising a data acquisition and analysis system, wherein the data acquisition and analysis system is configured to receive the generated first and second data signals and the first and second reference data signals to determine a level of moisture in the vapor phase in the fuel and moisture mixture.

8. The fuel moisturization sensor system of claim 1, wherein the flow path is situated within an enclosure comprising at least one window and wherein the first and second light sources are configured for emitting light through the at least one window.

9. The fuel moisturization sensor system of claim 8, further comprising at least one heating element situated proximate to the at least one window.

10. The fuel moisturization sensor system of claim 9, wherein the at least one heating element is turned on in response to a detected lowering of transmission at the second wavelength.

11. The fuel moisturization sensor system of claim 1, wherein light at the second wavelength is preferentially scattered by particulate matter in the fuel and moisture mixture to reduce transmittance at the second wavelength through the fuel and moisture mixture.

12. The fuel moisturization sensor system of claim 11, wherein reduction in transmittance at the second wavelength is used to determine a level of particulate matter in the fuel and moisture mixture.

13. A gasification system comprising:
a gasifier;
a fuel moisturization system;
a conduit for transferring fuel and moisture mixture from the fuel moisturization system to the gasifier; and
an on-line fuel moisturization sensor system disposed external to the gasifier, wherein the sensor system comprises:
a first light source configured for emitting light through a fuel and moisture flow path at a first wavelength, wherein the first wavelength is at least partially absorbable by the moisture when in a vapor phase and substantially not absorbable by the fuel; and
a first data detector, configured to detect light transmitted through the chamber at the first wavelength;
wherein at least a portion of the light transmitted through the chamber containing the fuel and moisture mixture, at the first wavelength, is detected by the first photodetector to generate a first data signal corresponding to the transmission of light at the first wavelength through the chamber.

14. The gasification system of claim 13, the sensor system further comprising a second light source emitting at a second wavelength, wherein the light at the second wavelength interrogates the chamber containing the fuel and moisture mixture, wherein the light at the second wavelength range is substantially not absorbable by the fuel and moisture in the vapor phase and is at least partially absorbable by moisture in the condensed phase in the chamber and a second data detector, configured to detect light transmitted through the chamber at the second wavelength to generate a second data signal.

15. The gasification system of claim 14, further comprising a data acquisition and analysis system, wherein the data acquisition and analysis system is configured to receive the generated first and second data signals and first and second reference data signals to determine a moisture to fuel ratio in the fuel and moisture mixture.

16. The gasification system of claim 13, further comprising a third light source configured for emitting light through the fuel and moisture flow path at a third wavelength, wherein the third wavelength is at least partially absorbable by the moisture when in a liquid phase and substantially not absorbable by the fuel or moisture when in a vapor phase, and wherein the detector system is further configured to detect light transmitted through the flow path at third wavelengths and to generate a third data signal corresponding to the transmission at the third wavelength.

17. The gasification system of claim 13, wherein the fuel moisturization system is configured to receive a determined moisture to fuel ratio data and operable to modify the moisture to fuel ratio in the fuel and moisture mixture.

18. A method for monitoring fuel moisturization levels comprising:
interrogating a fuel and moisture mixture with light at a first wavelength, wherein the first wavelength is at least partially absorbable by the moisture when in a vapor phase and substantially not absorbable by the fuel;
detecting light at the first wavelength transmitted through the fuel and moisture mixture to generate a data signal corresponding to light absorbed at the first wavelength by the moisture in a vapor phase along a path of light transmittance through the fuel and moisture mixture;
detecting a reference light signal at the first wavelength to generate a reference data signal corresponding to an intensity of the light at the first wavelength interrogating the fuel and moisture mixture; and
determining a moisture level in vapor phase in the fuel and moisture mixture.

19. The method of claim 18, wherein the fuel and moisture mixture is disposed within a chamber, wherein the method further comprises interrogating the chamber at a second wavelength and detecting light transmitted at the second wavelength through the chamber to generate a second data signal corresponding to a light scatter at the second wavelength by particulate matter along a path of light transmittance through the chamber.

20. The method of claim 18, further comprising detecting a reference light signal at the second wavelength to generate a reference data signal corresponding to an intensity of the light at the second wavelength interrogating the chamber.

21. The method of claim 18, wherein the method further comprises interrogating the chamber at a third wavelength and detecting light transmitted at the third wavelength through the chamber to generate a third data signal corresponding to light absorbed at the third wavelength by moisture in the liquid phase along the path of light transmittance through the chamber.

22. The method of claim 18, further comprising real time monitoring of moisture levels in the fuel and moisture mixture.

23. A fuel moisturization sensor system comprising:
a first light source configured for emitting light through a fuel and moisture flow path at a first wavelength, wherein the first wavelength is at least partially absorbable by moisture when in a vapor phase and substantially not absorbable by the fuel;
a second light source configured for emitting light through the fuel and moisture flow path at a second wavelength, wherein the second wavelength is preferentially scattered by particulate matter and substantially not absorbable by the fuel or by moisture when in a vapor phase;
a third light source configured for emitting light through the fuel and moisture flow path at a third wavelength, wherein the third wavelength is at least partially absorbable by the moisture when in liquid phase and substantially not absorbable by the fuel or moisture when in vapor phase; and
a detector system configured to detect light transmitted through the flow path at the first, second and third wavelengths and to generate a first data signal corresponding to the transmission at the first wavelength, a second data signal corresponding to the transmission at the second wavelength and a third data signal corresponding to the transmission at the third wavelength.

24. The system of claim 23, wherein the particulate matter is moisture in liquid phase.

25. The system of claim 23, wherein the first wavelength is selected to be in range from 925 to 975 nm, wherein the second wavelength is selected to be in range from 610 nm to 650 nm, and a third wavelength selected to be in a range from 1525 nm to 1575 nm.
